(19) United States
(12) Patent Application Publication
(10) Pub. No.: US 2005/0103409 A1
(43) Pub. Date: May 19, 2005

(54) Cleaning System for Surfaces Exposed to Poor Weather Conditions

(76) Inventor: Hugo Weber, Waltenhausen (DE)

Correspondence Address: TIGHE PATTON ARMSTRONG TEASDALE PLLC;PATENTS, BOX 66148, WASHINGTON SQUARE STATION, WASHINGTON, DC, 20035, US

(21) Appl. No.: 10/905,893

(22) Filed: Jan. 25, 2005

(30) Foreign Application Priority Data
Aug. 11, 2002 (WO) PCT/EP02/08995

(51) Int. Cl. C22F 1/08

(52) U.S. Cl. 148/684

(57) ABSTRACT

The invention concerns a cleaning system for surfaces exposed to poor weather conditions, in particular roof surfaces, solar heating systems or glass roofs. Said system comprises a plurality of reactive surfaces containing copper which produce, under the effect of natural moisture, compounds having a cleaning action, preferably of substances which eliminate bacteria, algae, fungi and/or lichens or at least stop their growth and/or eliminate pollutants derived from the environment. The invention is characterized in that the reactive surfaces are made of pure copper.

The invention relates to a cleaning device for surfaces exposed to the weather, in particular roof surfaces, solar installation surfaces, glass roofs or facades, the cleaning device having copper-containing reaction faces which, as a result of the action of natural moisture, generate surface-cleaning compounds, preferably substances which kill bacteria, algae, fungi and/or lichens or at least inhibit their growth and/or eliminate pollutants.

Similar cleaning devices are generally known, these known cleaning devices usually being in particular roof elements, such as, for example, metal roof tiles to be applied to the roof of a house. In this regard, preference is made, in particular, to the patent specification DE 44 13 119 C2 and the utility model specification DE 201 04 999 U1. Both publications relate to devices to be applied to a roof surface, these devices in each case being produced at least partially from copper plates according to the particulars in the publications. It is known that, in the presence of moisture, weathered copper plates give rise to the formation of substances which, as soon as they are applied over soiled surfaces, lead to a growth inhibition or the killing of bacteria, fungi, mosses, lichens and plants located there, with the result that the surfaces are ultimately cleaned automatically.

It became clear, however, that there are differences between these roof cleaning devices attributed essentially to the dwell time of the moisture in the region of the copper cleaning devices, and therefore, as is evident from the abovementioned publications, there have been attempts to enlarge the reaction surface of the copper materials as much as possible and ensure that the copper comes into contact with moisture for as long a duration as possible, in order to achieve sufficient reaction times for the formation of the desired cleaning substances. Although these enlarged surfaces were effective, the result has nevertheless been inadequate hitherto. Moreover, basic differences arose between the effectiveness of individual roof cleaning devices, the reason for which it has hitherto been impossible to explain.

The object of the invention is, therefore, to present a cleaning device which acts according to the principle described above and at the same time has optimum effectiveness.

This object is achieved by means of the features of the first claim. Further embodiments of the invention are the subject matter of the subclaims.

The inventor recognized that it is not sufficient to produce the above-mentioned cleaning devices from a simple copper plate. It is generally stated in the prior art that “copper” can be used as an especially effective metal, but no particular specification of the copper plate to be used is indicated. Thus, the production of such cleaning devices involves the commercially available plumber's plate which mostly serves for the production of dormer coverings, roof gutters or gutter tubes, or similar flat materials which are especially suitable for form-working.

As a result of the inventor's recognition, a copper alloy with relatively low copper fraction is used in the production of such plates. Copper/zinc alloys are usually concerned, which, in addition to the copper, have a high fraction of incorporations of other elements, in order to generate the desired material properties, such as, for example, bendabilty and tearing strength. A small selection of the copper types available is given, for example, in the “Taschenbuch für Maschinenbau” [“Manual of Mechanical Engineering”], double, 15th edition, pages 1378-1379. However, copper plates of this kind do not form the optimum surface for generating the desired effective compounds.

A further problem in the production of said cleaning devices is the processing of the raw material into copper plates. In this case, the compact copper material is rolled into its final flat material form by means of multiple rolling operations, oils or oil emulsions being applied in order to prevent cold-welding to the rollers and leading to a contamination of the surface. In addition, for the mostly used plumber's plate, as it is known, to generate a patination a passivation of the plates used is carried out, which generates a rapid patination of the plate. For this purpose, for example, a bath of benzotriazole, if appropriate with further additives, is used in order to accelerate patination.

However, for the cleaning device according to the invention, it is necessary to have available as clean a reaction surface as possible which consists only of copper and has no impurities due to other substances. This surface then exhibits the desired reaction with the atmosphere and from the reaction products, in conjunction with natural moisture, can generate a sufficient quantity of growth-inhibiting compounds. This can be achieved in that, after the production of the raw material of the cleaning device, surface impurities which may be generated are removed mechanically, thermally or chemically or, even better, do not occur at all during generation. Furthermore, the inventor recognized that cleaning devices of this type can serve not only for keeping roof surfaces clean, but also for keeping clean all surfaces exposed to the weather, these also being, in particular, solar installation surfaces, glass roofs or building facades.

Reference is additionally made also to the publication GB 2 146 055 A in which it is proposed to use “relatively” pure metal, in particular copper, for cleaning a roof, but nothing is said about the degree of purity and the surface treatment.

The previously published patent U.S. Pat. No. 6,253,495 B1 of the application himself also proposes, for a special version of a metal roof tile, to preoxidize the surface and to treat it with acids or lyes in conjunction with ultrasound, or by flaming and sandblasting. There is, however, no mention of the requisite purity of the copper.

The inventor, according to the idea of his invention, proposes to design the cleaning device known per se according to the independent patent claims.

This choice of the copper material which is not customary for the field of roof coverings has the effect that the reaction surfaces generate the desired cleaning compounds very quickly, and in this case, according to the current level of knowledge, essentially copper sulfate compounds occur.

Preferably, in this case, a copper material is used which is designed in such a way that, in a test of the surface according to DIN 50017 with 100% atmospheric moisture, with distilled water at 40° C., it has a visible oxidation layer after 4 days at the latest, preferably after 2 days at the latest.

It is advantageous, in this case, if the copper material has admixtures of at most 0.1%, a purity of the copper material being at least 99.95%, preferably 99.960% to 99.985%. These admixtures may advantageously be phosphorus, these preferably having a fraction of 0.015% to 0.040%.

Preferably, furthermore, a raw material from which the cleaning device is produced is used which passes through at least one rolling operation, chemical passivation of the surface being dispensed with.

Alternatively or additionally, the reaction surface can be freed of unwanted impurities by means of at least one thermal and/or chemical and/or mechanical cleaning operation. For example, the thermal cleaning operation may be an annealing operation which is carried out under protective gas or a vacuum, in which case the protective gas used may be, for example, a gas based on noble gas and/or nitrogen and/or CO₂.

The generation of a clean surface can take place mechanically in that the upper layer is removed mechanically, for example by grinding, planing or brushing. Furthermore, the surface can also be cleaned by sandblasting with sand, metal chips, preferably copper chips since these do not generate any new impurities, or glass.

Further features of the invention are the subject matter of the subclaims.

It goes without saying that the abovementioned features of the invention can be used not only in the combination specified in each case, but also in other combinations or alone, without departing from the scope of the invention.

1. A cleaning device for surfaces exposed to the weather, in particular roof surfaces, solar installation surfaces or glass roofs, the cleaning device having copper-containing reaction surfaces which, as a result of the action of natural moisture, generate surface-cleaning compounds, preferably substances which kill bacteria, algae, fungi and/or lichens or at least inhibit their growth and/or eliminate pollutants, characterized in that the copper material which forms the reaction surfaces is pure to low-alloy copper and, during production, is subjected to at least one rolling operation, and, after at least one rolling operation, at least one annealing operation for cleaning is carried out on the rolled surface.

2. The cleaning device as claimed in claim 1, characterized in that the surface is subjected to at least one annealing operation after the last rolling operation.

3. The cleaning device as claimed in claims 1 and 2, characterized in that the at least one annealing operation is carried out under protective gas.

4. The cleaning device as claimed in claim 3, characterized in that the protective gas used is a noble gas and/or nitrogen and/or CO₂, preferably in each case with additives for better cleaning.

5. The cleaning device as claimed in the preceding patent claim 3, characterized in that the at least one annealing operation is carried out under a vacuum.

6. The cleaning device as claimed in claim 1, characterized in that the copper material is designed in such a way that, in a test of the surface according to DIN 50017 with 100% atmospheric moisture, with distilled water at 40° C., it has an oxidation layer after 4 days at the latest, preferably after 2 days at the latest.

7. The cleaning device as claimed in one of the preceding patent claim 1, characterized in that the copper material has admixtures of at most 0.1%.

8. The cleaning device as claimed in claims 1 to 7, characterized in that the purity of the copper material is at least 99.95%, preferably 99.960% to 99.985%.

9. The cleaning device as claimed in claims 1 to 8, characterized in that the copper material has exclusively phosphorus as admixture, preferably in a fraction of 0.015% to 0.040%.

10. The cleaning device as claimed in claim 1, characterized in that a chemical passivation of the surface is dispensed with during the production of the raw material from which the cleaning device is produced and passes through at least one rolling operation.

11. The cleaning device as claimed in claims 1 to 10, characterized in that, to generate a clean surface, the upper layer is removed mechanically, preferably by grinding, planning or brushing.

12. A method for generating surface-cleaning compounds in cleaning devices for surfaces exposed to the weather, comprised of the steps of: providing copper material which forms the reaction surfaces is pure to low-alloy copper and, during production, is subjecting said copper material to at least one rolling operation, and, after at least one rolling operation, subjecting said copper material to at least one annealing operation for cleaning is carried out on the rolled surface. constructing the cleaning device for said surfaces with said copper material having said copper-containing reaction surfaces whereby surface-cleaning compounds are generated said as a result of the interaction of natural moisture with said copper-containing reaction surfaces.

13. The method as recited in claim 12, wherein said surface-cleaning compounds are substances which kill bacteria, algae, fungi and/or lichens or at least inhibit their growth and/or eliminate pollutants.

14. The method as recited in claim 12, wherein said exposed surfaces include: roof surfaces, solar installation surfaces, glass roofs or facades.
